(19) United States
(12) Patent Application Publication
(10) Pub. No.: US 2026/0273387 A1
(43) Pub. Date: Sep. 17, 2026

(54) PICTURE MADE OF DRAGÉES

(71) Applicant: Sándor Zsolt TOLNAI, Budapest (HU)

(72) Inventor: Sándor Zsolt TOLNAI, Budapest (HU)

(21) Appl. No.: 19/469,716

(22) PCT Filed: Mar. 6, 2024
(86) PCT No.: PCT/HU2024/050017

§ 371 Date: Sep. 26, 2025

(30) Foreign Application Priority Data
Mar. 30, 2023 (HU) P2300107
Aug. 14, 2023 (HU) P2300268

(51) Int. Cl. A63F 9/06; B44C 3/12

(52) U.S. Cl. CPC A63F 9/06; B44C 3/12

(57) ABSTRACT

The invention relates to a picture having a base surface. The picture according to the invention is characterized that the base surface consists of a back panel (5), a hole grid (2) disposed in front of the back panel (5), and a plurality of dragees (4) of various colours corresponding to the pattern of the picture (1) placed in the holes (3) of the hole grid (2).

### TECHNICAL FIELD

The invention relates to a picture having a base surface.

### BACKGROUND ART

Numerous picture puzzles are known that consist of various, interconnectable shaped parts.

Solving these puzzles is aided by the photograph of the completed picture, and the picture itself can be assembled repeatedly an arbitrary number of times. These picture puzzles are usually paper-and/or plastic-based.

The so-called Montessori developmental toys are also known, wherein balls of diverse colours are to be placed in holes of a horizontal hole grid; both the hole grid and the balls are made of wood. The wooden balls are larger than the holes of the hole grid where they are to be inserted, but in this case, due to the selected material (wood) this size difference does not result in a retaining effect that would allow the hole grid to be brought into a vertical position, the support base does not possess “resilience” which could effectively retain the inserted components also in a changed (vertical) position, i.e. in this case the components are retained in the horizontal, pan-shaped recesses only by gravity. This configuration also allows making a horizontally lying picture from confectionery products.

A disadvantage of the pictures made this way is that in order to raise them into a vertical position they must be provided with a transparent front panel, which involves that the glare and reflections caused by the material of the front panel (e.g. Perspex) reduces the visual impact of the picture, occasionally—depending on the lighting conditions—even to the point of invisibility. Furthermore, the surface of the confectionery products forming the picture may become cracked over time or their colours may fade, but the integral structure of the Perspex plate and the support structure does not allow their replacement.

Other such toys are also known wherein the picture is made utilising confectionery products. Such a solution is disclosed in the video _{“}Make Pixel Art Portraits with Skittles” (https://youtu.be/REjFtvBTPMc, uploaded 9 Jul. 2020). The picture assembled from several thousand components can be brought to a vertical position thanks to applying adhesive bonding utilising a “glue gun”, i.e., each confectionery product is affixed one-by-one, applying adhesive bonding, without that the completed picture cannot be placed on a vertical surface.

Making pictures from confectionery products by adhesive bonding has the following disadvantages:
gluing makes the confectionery products unfit for consumption,
it cannot be considered a long-term solution, i.e. there is a high risk that some of the confectionery products will fall out because some of the several thousand adhesive connections come loose, it is also cumbersome to implement because of the formation of glue filaments and glue drops that deteriorate the aesthetic impression of the picture.
furthermore, if the entire back surface of the picture is treated with adhesive and the components are placed thereon one-by-one, then dust will build up or insects will get stuck on the uncovered parts of the adhesive surface, which also deteriorates visual impression,
the confectionery products cannot be replaced in case they become faded or cracked.

### DISCLOSURE OF INVENTION

The objective of the present invention is to provide—eliminating the known disadvantages—a picture that is preferably located on a vertical surface and that can be prepared easily applying single-coloured elements with a colour palette with a low number of colours, the elements being confectionery products.

The present invention is based on the recognition that the confectionery product—dragée—to be applied has a lenticular shape, i.e., a unidirectionally flattened spherical shape that has a circular projection—the greater diameter of the dragée—which projection at the same time also serves as a pixel of the picture to be prepared, and also has an elliptical projection (or view) perpendicular to that, with the greater diameter of the elliptical projection being identical with the above mentioned circular diameter but the projection also has a smaller diameter, i.e., it is flattened. The invention is also based on the law of geometry dictating that a circular-flat shape of a given diameter cannot pass through a circular hole having a smaller diameter. Therefore, we envisioned that in our solution to be set forth below the dragées are tightly received between two circular holes with smaller diameter than their diameter and are retained securely there in a resilient layer.

The objective of the present invention is to provide a picture prepared from confectionery products that can be positioned vertically, with the confectionery products remaining in vertical position for a prolonged period of time even without adhesive bonding, and with 95% of the coloured surface of the confectionery products remaining visible.

This can be realised applying grid structure having a thickness that is smaller than the smaller (flat) diameter of the lenticular-shaped dragées forming the picture, with the diameter of the circular holes of the support structure receiving the dragées being smaller than the greatest circular diameter of the dragées.

The support structure consists of two layers having smaller resilience, preferably cardboard sheets, and a soft, resilient layer, preferably plastic foam located between the two layers.

The pressure force applied on the dragée during the insertion causes a temporary deformation of the narrow circular hole of the cardboard sheet, which enables the dragée to pass through the hole; behind the dragée, the temporarily expanded cardboard contracts to its original size, while the dragée becomes inserted in the soft intermediate layer where it remains fixed without further forces acting on it. The dragée cannot fall out from its place, because neither the shape memory motions of the soft plastic foam layer, nor the gravitational force acting on the dragée can expand again the “exit” in the cardboard that has contracted to its initial size.

The objective of the invention is realised by a picture comprising a base surface provided with a pattern and a hanging member for facilitating the application of the picture, the picture being characterised in that the base surface consists of a back panel, a hole grid disposed in front of the back panel, and a plurality of dragées of various colours corresponding to the pattern of the picture placed in the holes of the hole grid.

In a preferred embodiment of the picture according to the invention, the dragées placed in the holes of the hole grid of the base surface are preferably sugar-coated lenticular-shaped dragées.

In a preferred embodiment of the picture according to the invention, the dragées placed in the holes of the hole grid of the base surface are preferably sugar-coated lenticular-shaped dragées, and the dragées are inserted in the hole grid such that they can be removed under force without causing them damage.

In a preferred embodiment of the picture according to the invention, the hole grid of the base surface is a hole grid with circular holes, the hole grid further comprising an additional soft layer placed between two cardboard sheets, where the intermediate layer is preferably made from corrugated paper or-plastic foam.

In a preferred embodiment of the picture according to the invention the diameter of the holes of the hole grid is configured to be smaller than the greatest diameter of the dragées to be inserted therein.

In all preferred embodiments of the picture according to the invention the sugar-coated dragées disposed in the holes of the hole grid of the base surface are selected from the following group: M&M's chocolate dragées, Smarties, Skittles, Reese's Pieces, Diabolo, BigHit, Schokolinsen, private label products, or other lenticular-shaped confectionery dragées, and the back panel of the base surface is provided with a colour code table for assisting in forming the pattern of the picture, where the back panel is made from sponge sheet and is affixed—preferably by adhesive bonding—to a cardboard sheet.

A preferred embodiment of the picture according to the invention comprises one or more hanging members adapted for hanging the completed picture on a vertical wall surface, where the hanging members are formed of two fabric strips fixed by adhesive between the sponge back panel 5 and the additional cardboard sheet adapted for stiffening the back panel.

### BRIEF DESCRIPTION OF DRAWINGS

A preferred embodiment of the picture according to the invention will be described in detail below referring to the accompanying drawings, where

FIG. 1 is the front view of a completed picture according to the invention, placed on a vertical surface,

FIG. 2 shows the hole grid of the base surface of a picture according to the invention,

FIG. 3 is a perspective view of a dragée inserted into the hole grid according to FIG. 2,

FIG. 4 shows a detail of the picture according to FIG. 1,

FIG. 5 is a sectional view taken along plane A-A of FIG. 4,

FIG. 6 shows a detail of the back panel of a picture according to FIG. 1 having a colour code table.

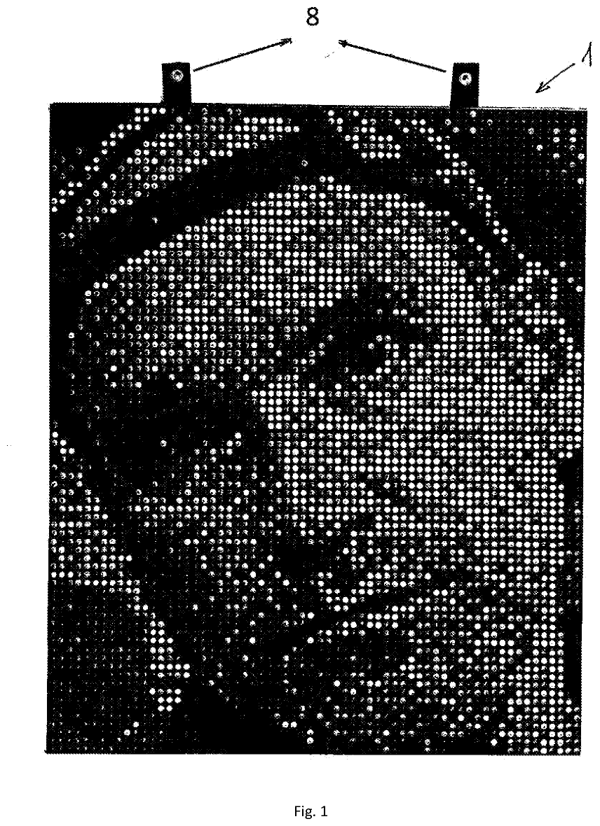

In FIG. 1 there can be seen a completed picture 1 according to the invention, the pattern of the picture-in this case a male portrait-being formed by a plurality of dragées.

Hanging members 8 enabling the picture 1 to be placed on a vertical surface are disposed on the top portion of the picture 1.

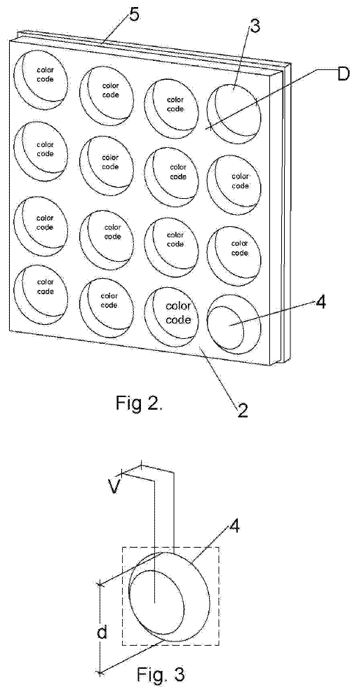

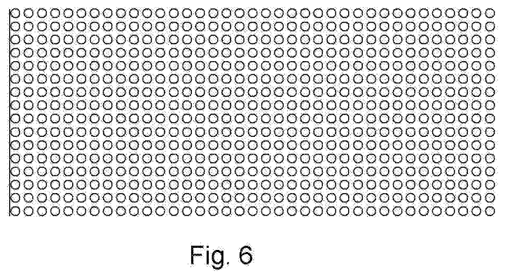

In FIG. 2 a portion of the base surface of the picture 1 can be seen, which consists of a printed sponge back panel 5 that is provided with a colour code table (see FIG. 6) and delimits the picture 1 at the rear, and a hole grid 2 that is fixed—preferably by adhesive—to the surface of the back panel 5 bearing the colour code table, the hole grid preferably comprising a circular hole grid.

The confectionery products, i.e., dragées 4 forming the pattern of the picture are inserted into the holes 3 of the hole grid according to the colour code table of the back panel 5.

FIG. 3 shows a perspective view of a dragée 4.

The dragées 4 have a diameter d and thickness v, with the dimensions of the dragées 4 conforming to the dimensions of the hole grid 2 according to FIG. 2 such that the dimension D of the holes 3 (see FIG. 2) of the hole grid 2 is smaller than the dimension d of the dragées 4.

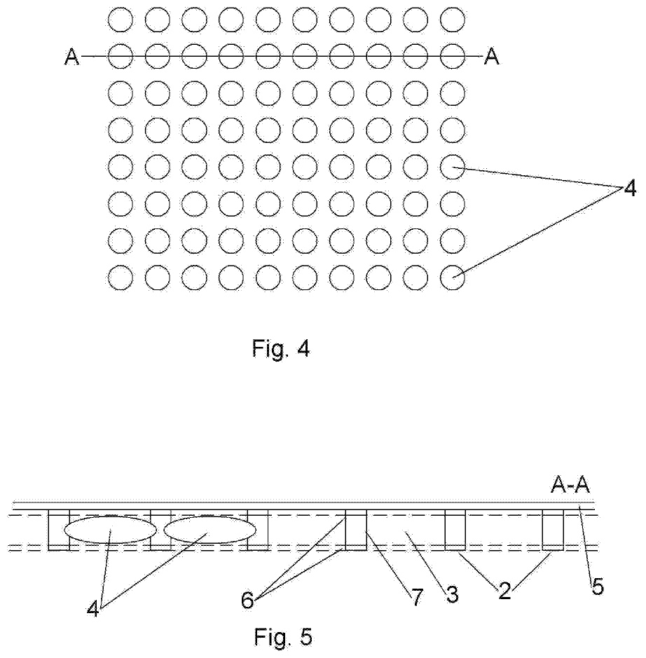

In FIG. 4 a magnified detail of the completed picture 1 is shown, with dragées 4 of various colours.

FIG. 5 is a sectional view taken along plane A-A of FIG. 4, clearly showing the configuration of the hole grid 2. The hole grid 2 consists of two cardboard sheets 6 and a resilient intermediate layer 7 that is disposed between the cardboard sheets 6 and is fixed to the cardboard sheets 6.

In this embodiment the intermediate layer 7 consists of plastic foam material, but it can also be made from corrugated paper.

The dragées 4 are to be placed into the holes 3 of the hole grid 2. The hole grid 2 is delimited at the rear by the back panel 5 provided with a colour code table. The back panel 5 is preferably a sponge plate adhesively bonded to a corrugated board.

The function of the colour code table disposed on the back panel 5 and the preparation of the picture will be described in the following.

For the sake of clarity, it has to be noted that before preparing the picture according to the invention, as a first step, the picture on which the picture 1 will be based is selected on a computer. The region of chosen digital image that is to be included in the picture is cropped and is subjected to various photo manipulation operations.

It is noted that for example in the case of a portrait the picture can be a picture of 64×78 pixels, which therefore contains 4992 pixels, and can be prepared using the same number of dragées 4.

The number of dragées 4 to be utilised will of course vary in accordance with the varying dimension of the picture.

Thereafter, the colour code table according to FIG. 6 is generated from the processed digital image, which in the case of the picture described in the present example includes 64 rows and 78 columns and shows the colour of the dragées 4 to be inserted in each hole 3 of the hole grid 2 of the picture 1. The abbreviations included in the table refer to the colours of the dragées 4, where e.g. “pin”=pink, “söz”=dark green (“sötétzöld”), “Na”=orange (“narancs”), “Fe”=black (“fekete”), etc.

The picture to be prepared can be made utilising sugar-coated dragées 4 from various manufacturers, i.e. for example M&M's chocolate dragées, Smarties, Skittles, Reese's Pieces, Diabolo, BigHit, Schokolinsen, private-label, or other confectionery dragées having lenticular shape can be used, which have circular shape when placed on a horizontal surface and seen from above, and a flattened oval shape when seen in a side view, and therefore—as it was set forth above—have two different diameters.

The hole grid 2 is then made in accordance with the dimensions of the dragées 4.

With the help of the digital image forming the basis of the picture 1 and the colour code table shown in FIG. 6, the picture 1 according to the invention can be prepared as follows:

The picture 1 can be prepared in either a vertical or a horizontal position of the base surface. A hole grid 2 consisting of holes having a diameter D that is smaller by 0.5-2 mm than the diameter d of the dragées 4 is formed from a thin sheet-like material that has a thickness smaller by 0.5-2 mm than the smaller (elliptic) diameter of the dragées 4 and is bounded at both sides by a cardboard sheet 6 (see FIG. 5). Due to the slight flexibility of the cardboard sheet 6, the dragée 4 can pass through the hole 3 when pressed with a finger. Passing through the hole is also facilitated by the low-radius curvature of the elliptic shape of the dragée 4 at its edge, i.e., the circular hole 3 is temporarily expanded while pressure is applied on the dragée 4, the dragée 4 passes through the hole, and, when the pressure is no longer applied, the hole of the cardboard sheet 6 shrinks to its initial size, and the dragée is retained by the resilient intermediate layer 7.

The resilient-material intermediate layer 7 between the two cardboard sheets 6 is a plastic foam layer. This intermediate layer 7 receives and retains in place the dragées 4 after they have passed through the holes 3 of the cardboard sheet 6 constituting the first layer. The dragées 4 cannot fall out because the circular diameter of the dragées 4 is greater (by 0.5-2 mm) than the holes 3 of the hole grid 2, i.e., they have already snapped therein under force. Having regained their initial diameter, the holes 3 of the cardboard sheet 6 fit tightly against the dragées 4, fixing them inside the intermediate layer 7. The inserted dragées 4 are supported from behind by the second cardboard sheet 6 and a sponge back panel 5. The second cardboard sheet 6 layer is affixed to a pack panel 5 including the colour palette—colour code table—according to FIG. 6, the back panel 5 preferably being a sponge sheet adhesively bonded to a corrugated board. This is required because the confectionery dragées slightly protrude from the plane of the carboard sheets 6 both at the back and at the front, as the thickness of the intermediate plastic foam layer 7 is chosen such that the sandwich structure 6-7-6 of the support structure is thinner by 0.5-2 mm than the smaller elliptic diameter (v) of the dragées. The backward protrusion of the dragées is taken up by the resilience of the sponge layer of the back panel 5, while at the front the dragées freely protrude from the surface, improving the visibility of their diverse colours that form the pixels. The numerous lenticular dragées arranged in an appropriate pattern inside the support structure form a picture, while they are securely retained in a prolonged manner, and the method enables the picture to be placed vertically without applying adhesive bonding to the dragées.

The description included above relates to preparing a picture 1 with a size of 64×78 pixels.

The configuration according to the invention allows for producing any such picture 1 that is desired by the customer, which picture can then be completed by filling it up with the dragées 4 also chosen by the customer. For affixing the completed picture 1 to a vertical surface, two fabric strips are inserted into the sponge material glued to the corrugated board 5, i.e. between the sponge material and the corrugated board. The hanging member 8 is constituted by these fabric strips. By placing an additional component, for example a tubular rivet on the hanging member 8, the picture 1 can be secured to the vertical surface.

The advantages of the invention are that pictures with any reasonable dimensions can be made, the picture can be placed on a vertical surface, where, thanks to the resilient material of the applied grid structure, the dragées can be retained without applying adhesive or a transparent cover sheet. If necessary, the confectionery products forming the picture can be replaced due to their surface becoming cracked or their colour becoming faded, however, they remain edible and can be removed or replaced at any time.

The board formed in such a manner can be hung on the wall even before inserting the dragées, followed by pressing (snapping) the dragées of the appropriate colour in the holes representing the pixels, thereby forming the desired picture.

A further advantage of the invention is that the manufacturer does not need to complete the pictures in the factory, i.e., the users themselves may be trusted with inserting the dragées in the hole grid, because the invention allows the users to easily and safely create the pictures by inserting the supplied dragées of appropriate colour into the hole grid 2 according to the assembly instructions virtually provided by the codes included on the back panel 5, and thus creating the picture for example on the wall of his or her room, having fun while experiencing the joy of creation. Pictures made this way are as durable and good-looking as if they were shipped assembled by the manufacturer.

The technical solution according to the invention has the following advantages:
each of the numerous dragées is individually fixed in a secure manner,
the picture can be safely placed on vertical surfaces,
the picture does not have a shiny and heavy front panel,
the confectionery products constituting the picture still remain consumable,
the components can be non-destructively replaced at any time,
the picture can be prepared easily and playfully.

### LIST OF REFERENCE NUMERALS

1 picture
2 hole grid
3 hole
4 dragée
5 sponge back panel
6 cardboard sheet
7 intermediate layer
8 hanging tab

1. A picture (1) comprising a base surface provided with a pattern, and a hanging member for facilitating the hanging of the picture, the base surface comprising a back panel (5), a hole grid (2) having a plurality of holes (3) disposed in front of the back panel (5), and a plurality of dragées (4) of various colours corresponding to the pattern of the picture (1) in the holes (3) of the hole grid (2) characterised in that the hole grid (2) comprises a flexible intermediate layer (7) flanked on both sides by a relatively less flexible facing layer (6).

2. The picture (1) according to claim 1, characterised in that said flexible intermediate layer (7) is corrugated paper.

3. The picture (1) according to claim 1, characterised in that said flexible intermediate layer (7) is plastic foam.

4. The picture (1) according to claim 1, characterised in that the hole grid (2) of the base surface comprises circular holes.

5. The picture (1) according to claim 1, characterised in that the dragées are sugar-coated lenticular-shaped dragées (4).

6. The picture (1) according to claim 1, characterised in that the holes (3) of the hole grid (2) have a diameter smaller than the largest diameter of the dragées (4) to be inserted therein.

7. The picture (1) according to claim 1, characterised in that the back panel (5) is made of sponge sheet material and is provided with a colour code table visible through the hole grid for assisting in forming a pattern of the picture.

8. The picture (1) according to claim 1, characterised in that said hanging member is formed of two fabric strips fixed to an outer surface of the back panel (5) by adhesive.

9. The picture (1) according to claim 8, characterised in that a cardboard covering the hanging member is attached to the back panel (5).

10. The picture (1) according to claim 1, wherein the relatively less flexible facing layer (6) is cardboard.

11. The picture (1) according to claim 7, wherein the color code table is fixed to the back panel by an adhesive.
